(19) United States
(12) Patent Application Publication
(10) Pub. No.: US 2006/0149938 A1
(43) Pub. Date: Jul. 6, 2006

(54) Determining a register file region based at least in part on a value in an index register

(76) Inventors: Hong Jiang, San Jose, CA (US); Val Cook, Shingle Springs, CA (US); Thomas A. Piazza, Granite Bay, CA (US); Michael K. Dwyer, El Dorado Hills, CA (US)

Correspondence Address: Buckley, Maschoff & Talwalkar LLC;INTEL Corporation, Five Elm Street, New Canaan, CT, 06840, US

(21) Appl. No.: 11/025,105

(22) Filed: Dec. 29, 2004

(51) Int. Cl. G06F 15/00

(52) U.S. Cl. 712/225; 712/22

(57) ABSTRACT

According to some embodiments, a value is retrieved from a location in an index register. A region in a register file may then be determined based at least in part on the value. Information may then be stored into the determined region of the register file.

### BACKGROUND

To improve the performance of a processing system, a Single Instruction, Multiple Data (SIMD) instruction is simultaneously executed for multiple operands of data in a single instruction period. For example, an eight-channel SIMD execution engine might simultaneously execute an instruction for eight 32-bit operands of data, each operand being mapped to a unique compute channel of the SIMD execution engine. Moreover, one or more registers in a register file may be used by SIMD instructions, and each register may have fixed locations associated with execution channels (e.g., a number of eight-word registers could be provided for an eight-channel SIMD execution engine, each word in a register being assigned to a different execution channel). An ability to efficiently and flexibly access register information in different ways may further improve the performance of a SIMD execution engine.

### BRIEF DESCRIPTION OF THE DRAWINGS

FIGS. 1 and 2 are block diagrams of processing systems.

FIG. 3 illustrates an instruction and a register file for a processing system.

FIG. 4 is a flow chart of a method according to some embodiments.

FIG. 5 is a block diagram of a processing system according to some embodiments.

FIG. 6 illustrates an index register storing values for multiple operands according to some embodiments.

FIG. 7 illustrates an index register storing non-aligned values for multiple operands according to some embodiments.

FIG. 8 is a flow chart of a method according to some embodiments.

FIG. 9 is a block diagram of a processing system according to some embodiments.

FIG. 10 illustrates execution channel mapping in a register file according to some embodiments.

FIG. 11 illustrates a region description including a horizontal stride according to some embodiments.

FIG. 12 illustrates a region description including a horizontal stride of zero according to some embodiments.

FIG. 13 illustrates a region description for word type data elements according to some embodiments.

FIG. 14 illustrates a region description including a vertical stride according to some embodiments.

FIGS. 15 and 16 illustrate a register index storing multiple values for a region according to some embodiments.

FIG. 17 illustrates a region description including a vertical stride of zero according to some embodiments.

FIG. 18 illustrates a register index such that a single data element may be associated with multiple execution channels according to some embodiments.

FIG. 19 illustrates a register index such that a sliding window may be provided according to some embodiments.

FIG. 20 illustrates a region description wherein both the horizontal and vertical strides are zero according to some embodiments.

FIG. 21 illustrates region descriptions according to some embodiments.

FIG. 22 illustrates an index register storing values for each data element in a region according to some embodiments.

FIG. 23 is a block diagram of a system according to some embodiments.

### DETAILED DESCRIPTION

Some embodiments described herein are associated with a “processing system.” As used herein, the phrase “processing system” may refer to any device that processes data. A processing system may, for example, be associated with a graphics engine that processes graphics data and/or other types of media information. In some cases, the performance of a processing system may be improved with the use of a SIMD execution engine. For example, a SIMD execution engine might simultaneously execute a single floating point SIMD instruction for multiple channels of data (e.g., to accelerate the transformation and/or rendering three-dimensional geometric shapes). Other examples of processing systems include a Central Processing Unit (CPU) and a Digital Signal Processor (DSP). Note that any of the embodiments described herein may be associated with other types of processing systems, including a Multiple Instruction, Multiple Data (MIMD) execution engine.

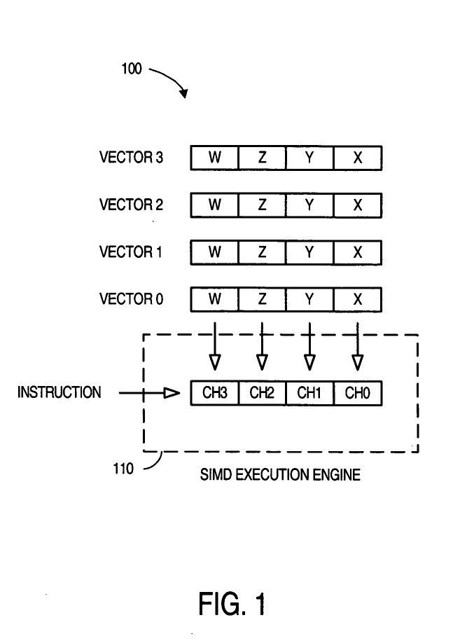

FIG. 1 illustrates one type of processing system 100 that includes a SIMD execution engine 110. In this case, the execution engine 110 receives an instruction (e.g., from an instruction memory unit) along with a four-component data vector (e.g., vector components X, Y, Z, and W, each having bits, laid out for processing on corresponding channels 0 through 3 of the SIMD execution engine 110). The engine 110 may then simultaneously execute the instruction for all of the components in the vector. Such an approach is called a “horizontal,” “channel-parallel,” or “Array Of Structures (AOS)” implementation.

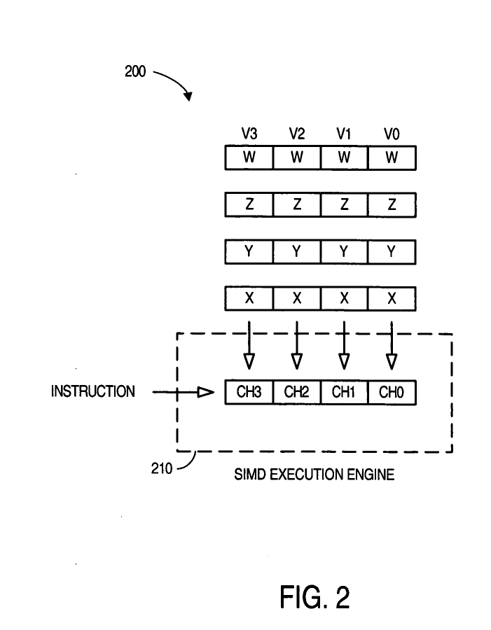

FIG. 2 illustrates another type of processing system 200 that includes a SIMD execution engine 210. In this case, the execution engine 210 receives an instruction along with four operands of data, where each operand is associated with a different vector (e.g., the four X components from vectors V0 through V3). Each vector may include, for example, three location values (e.g., X, Y, and Z) associated with a three-dimensional graphics location. The engine 210 may then simultaneously execute the instruction for all of the operands in a single instruction period. Such an approach is called a “vertical,” “channel-serial,” or “Structure Of Arrays (SOA)” implementation. Although some embodiments described herein are associated with a four and eight channel SIMD execution engines, note that a SIMD execution engine could have any number of channels more than one (e.g., embodiments might be associated with a thirty-two channel execution engine).

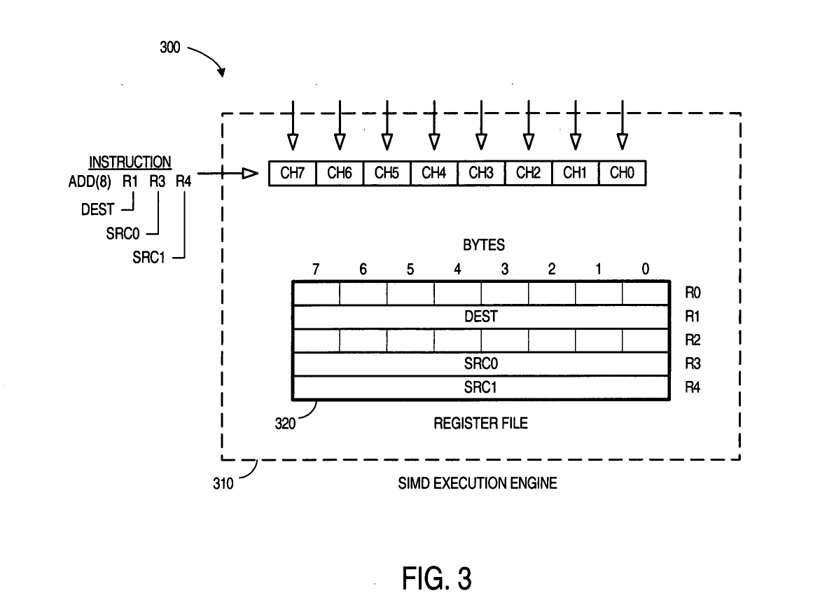

FIG. 3 illustrates a processing system 300 with an eight-channel SIMD execution engine 310. The execution engine 310 may include an eight-byte register file 320, such as an on-chip General Register File (GRF), that can be accessed using assembly language and/or machine code instructions. In particular, the register file 320 in FIG. 3 includes five registers (R0 through R4) and the execution engine 310 is executing the following hardware instruction:

add(8) R1 R3 R4

The “(8)” indicates that the instruction will be executed on operands for all eight execution channels. The “R1” is a destination operand (DEST), and “R3” and “R4” are source operands (SRC0 and SRC1, respectively). Thus, each of the eight single-byte data elements in R4 will be added to corresponding data elements in R3. The eight results are then stored in R1. In particular, the first byte of R4 will be added to the first byte of R3 and that result will be stored in the first byte of R1. Similarly, the second byte of R4 will be added to the second byte of R3 and that result will be stored in the second byte of R1, etc.

In some applications, it may be helpful to access information in a register file in various ways. For example, in a graphics application it might at some times be helpful to treat portions of the register file as a vector, a scalar, and/or an array of values. Such an approach may help reduce the amount of instruction and/or data moving, packing, unpacking, and/or shuffling and improve the performance of the system. Moreover, when a register file has a relatively large number of registers (e.g., one hundred registers), it might be helpful to let an application kernel maintain kernel data in a pre-determined register file location (e.g., in a manner similar to a software managed data cache).

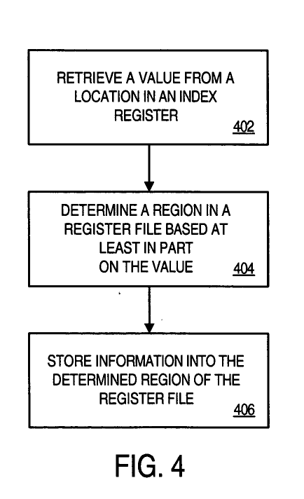

FIG. 4 is a flow chart of a method according to some embodiments. The flow charts described herein do not necessarily imply a fixed order to the actions, and embodiments may be performed in any order that is practicable. Note that any of the methods described herein may be performed by hardware, software (including microcode), firmware, or any combination of these approaches. For example, a hardware instruction mapping engine might be used to facilitate operations according to any of the embodiments described herein.

At 402, a value is retrieved from a location in an index register. The value might indicate, for example, which of a number of different registers in a register file should be used as a source operand or a destination operand. Note that the appropriate location in the index register might be encoded in a machine code instruction, and that location's current value might have been determined and stored by an application at run-time.

At 404, a region in a register file is determined based at least in part on the value. For example, the region might simply be a particular register in the register file that will be used as an operand. Information may then be stored into (and/or retrieved from) the determined region of the register file at 406.

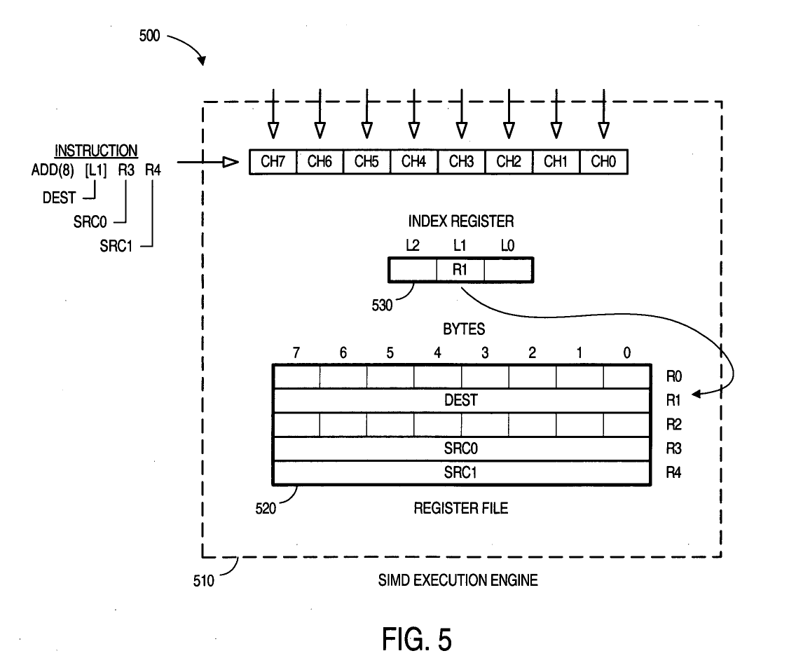

FIG. 5 illustrates a processing system 500 with an eight-channel SIME execution engine 510 according to some embodiments. A register file 520 includes five registers (R0 through R4), and the execution engine 510 is executing the following hardware instruction:

add(8) [L1] R3 R4

The “(8)” indicates that the instruction will be executed on operands for all eight execution channels. The R3 and the R4 are source operands (SRC0 and SCR1, respectively) and indicate that information from those registers should be added together.

The brackets in “[L1]” indicate that this operand is being defined at least in part based on a value in an index register 530 (e.g., in accordance with a register-indirect-register addressing mode). In particular, a value at location “L1” of the index register 530 will indicate which register of the register file 520 should be the destination operand (DEST). In the example illustrated in FIG. 5, the result generated when R4 is added to R3 will be stored in R1. That is, each of the eight single-byte data elements in R4 will be added to corresponding data elements in R3, and the eight results are then stored in R1 (the first byte of R4 will be added to the first byte of R3 and that result will be stored in the first byte of R1, etc.).

The index register 530 may be, for example, a dedicated storage area that is used only for indexing purposes. According to some embodiments, the index register 530 may also be used for other purposes. For example, a portion of the register file 520 might be designated as the index register 530 (e.g., the designation might be made by an instruction word or an architectural state register).

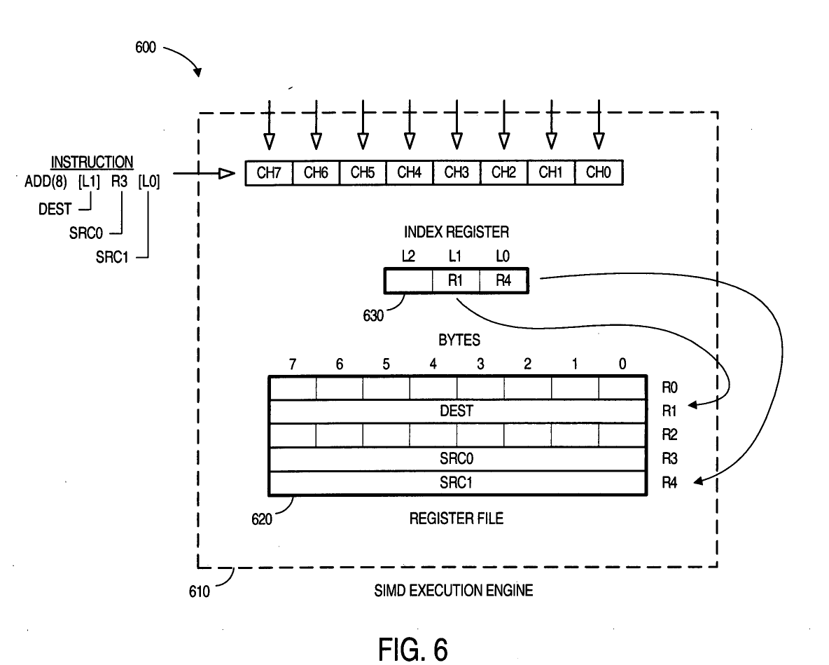

According to some embodiments, an index register might store multiple values associated with a single instruction. For example, FIG. 6 illustrates a processing system 600 with an eight-channel SIMD execution engine 610 and a five-register register file 620. The execution engine 610 is executing the following hardware instruction:

add(8) [L1] R3 [R0]

As before, R3 is source operand SRC0 and “L1” indicates that the value at location L1 in the index register 630 will define a destination operand DEST. In this case, source operand SRC1 is defined by a value at another location L0 in the index register. As illustrated in FIG. 6, location L0 indicates that R4 should be used as SRC1.

Note that any combination of immediate, register, and/or register-indirect-register addressing may be applied to operands. For example, the execution engine 610 might execute:

add(8) [L3] [L1] [L0],
add(8) R3 [L1] [L0]

etc. In addition, although some examples discussed herein have two source operands and one destination operand, other types of instructions may be used. For example, an instruction might have one source operand and one destination operand, three source operands and two destination operands, etc.

Also note that the index register 630 does not need to be same size as the registers in the register file 620. Similarly, the locations within the index register 630 may be of various sizes. Moreover, a value within the index register 630 might point to a register, a byte, a bit, or another type of location within the register file 620.

For example, the value stored in the index register 630 might simply be an integer from 0 through 4 indicating which of the five registers in the register files 620 should be used. According to some embodiments, the value in the index register 630 may define an origin of a region in the register file 620. For example, the value might represent a register identifier and a “sub-register identifier” indicating a location of a first data element within a register.

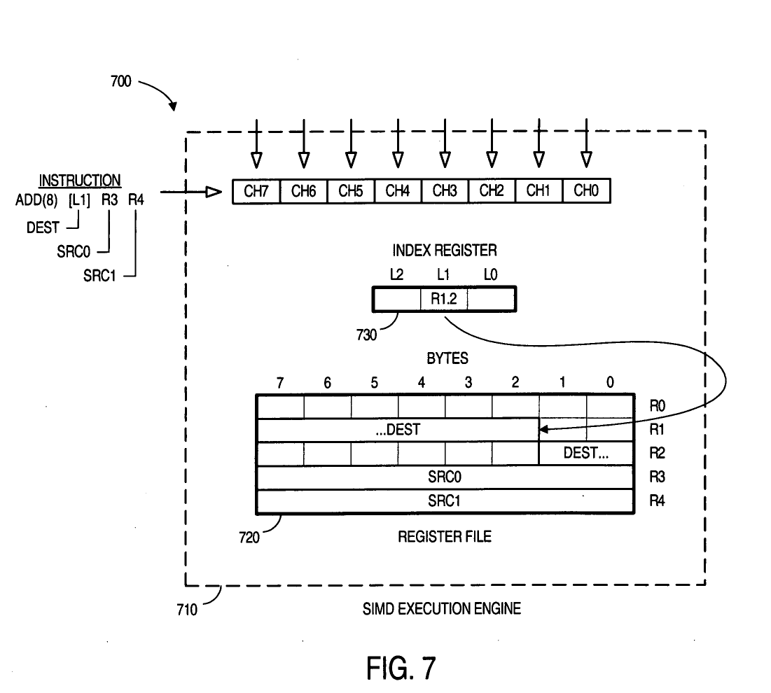

FIG. 7 illustrates a processing system 700 with an eight-channel SIMD execution engine 710 and a five-register register file 720. The execution engine 710 is executing the following instruction:

Add(8) [L1] R3 R4

As before, R3 and R4 are source operands SRC0 and SRC1 and a value stored at location L1 of the index register 730 will be used to determine DEST. In this case, the value stored in the index register 730 represents an “origin” of RegNum.SubRegNum. The sub-register identifier might indicate, for example, an offset from the start of a register (e.g., and may be expressed using a physical number of bits or bytes or a number of data elements). For example, the DEST region in FIG. 7 has an origin of R1.2, indicating that first data element in the DEST region is located at byte two of register R1. Note that the described regions do not need to be aligned within the register file 720 (e.g., a region does not need to start at byte 0 and end at byte 7 of a single register). Also note that a region may span multiple registers (e.g., DEST beings in R1 and ends in R2).

Note that the index register 730 may contain a complete region description, or part of a region description. That is, an index register 730 may contain a register description, in whole or in part, of the location of the operand in the register file 720. For example, the index register 730 may contain the exact integer location of a SIMD 8-wide register location of the operand. In another example, the index register 730 may contain a complete description of a region-based register which algorithmically maps 8 locations in the register file to the 8 channel positions of the operand. As a further example, an index may contain only a partial description of the mapping, which when combined with the remaining description either from the instruction word or from some other base description in a storage element, defines a complete mapping of registers to the 8-wide operand.

An origin might be defined in other ways. For example, the register file 720 may be considered as a contiguous 40-byte memory area. Moreover, a single 6-bit address origin could be stored in the index register 730 to represent any byte within the register file 720. Note that a single 6-bit address origin is able to point to any byte within a register file of up to 64-byte memory area. As another example, the register file 720 might be considered as a contiguous 320-bit memory area. In this case, a single 9-bit address origin could be stored in the index register 730.

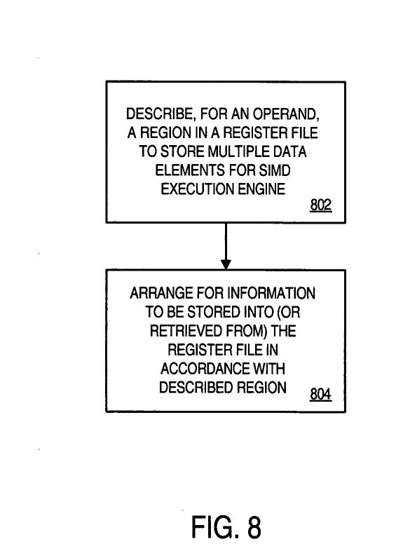

To provide additional flexibility, FIG. 8 is a flow chart of a method according to some embodiments. At 802, a region in a register file is described for an operand. The operand might be, for example, a destination or source operand of a machine code instruction to be executed by a SIMD execution engine. According to some embodiments, the described region is “dynamic” in that different regions in the register file may be defined at different times. The description of the region might be, for example, encoded in the machine code instruction. Note that more than one region in the register file might be described at one time.

At 804, it is arranged for information to be stored into (or retrieved from) the register file in accordance with the described region. For example, data from a first region might be compared to data in a second region, and a result might be stored in a third region on a per-channel basis.

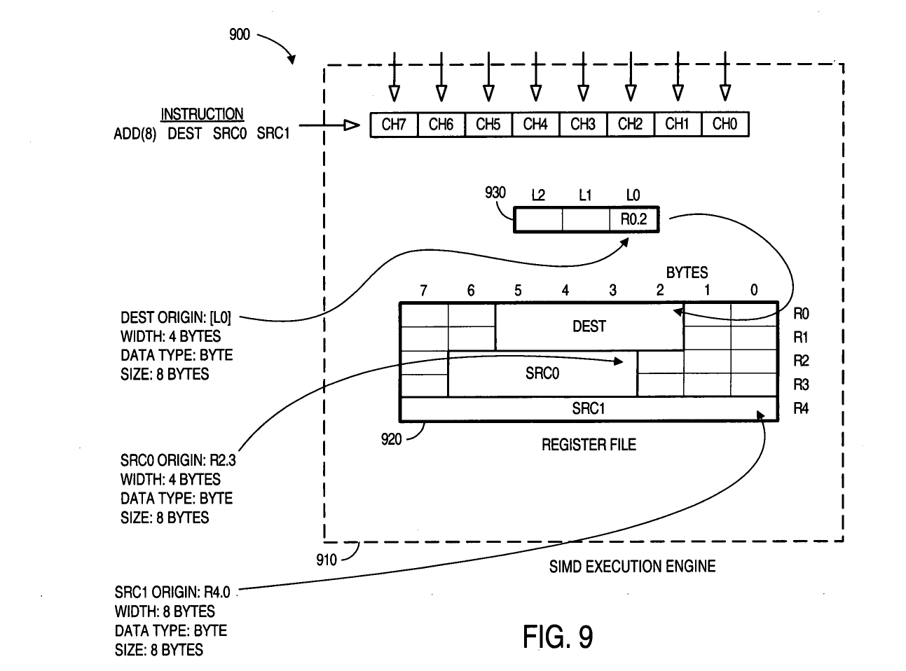

FIG. 9 illustrates a processing system 900 with an eight-channel SIMD execution engine 910 according to some embodiments. In this example, three regions have been described for a register file 920 having five eight-byte registers (R0 through R4): a destination region (DEST) and two source regions (SRC0 and SRC1). The regions might have been defined, for example, by a machine code add instruction. Moreover, in this example all execution channels are being used and the data elements are assumed to be bytes of data (e.g., each of eight SRC1 bytes will be added to corresponding SRC0 bytes and the results will be stored in eight DEST bytes in the register file 920).

The region descriptions of SRC0 and SRC1 include a register identifier and a sub-register identifier indicating a location of a first data element in the register file 920. With respect to DEST, an index register 930 will store a value in location LO representing the register identifier and sub-register identifier (which, in the example illustrated in FIG. 9, results in byte two of R0 being used as the DEST origin). In this example, a single value in the index register 930 points to a register region origin while the rest of the region parameters are described by the immediate instruction field.

Some or all of the region descriptions may include a “width” of the region. The width might indicate, for example, a number of data elements associated with the described region within a register row. For example, the DEST region illustrated in FIG. 9 has a width of four data elements (e.g., four bytes). Since eight execution channels are being used (and, therefore eight one-byte results need to be stored), the “height” of the region is two data elements (e.g., the region will span two different registers). That is, the total number of data elements in the four-element wide, two-element high DEST region will be eight. The DEST region might be considered a two dimensional array of data elements including register rows and register columns.

Similarly, the SRC0 region is described as being four bytes wide (and therefore two rows or registers high) and the SRC1 region is described as being eight bytes wide (and therefore has a vertical height of one data element). Note that a single region may span different registers in the register file 920 (e.g., some of the DEST region illustrated in FIG. 9 is located in a portion of R0 and the rest is located in a portion of R1).

Although some embodiments discussed herein describe a width of a region, according to other embodiments a vertical height of the region is instead described (in which case the width of the region may be inferred based on the total number of data elements). Moreover, note that overlapping register regions may be defined in the register file 920 (e.g., the region defined by SRC0 might partially or completely overlap the region defined by SRC1). In addition, although some examples discussed herein have two source operands and one destination operand, other types of instructions may be used. For example, an instruction might have one source operand and one destination operand, three source operands and two destination operands, etc.

According to some embodiment, a region origin (e.g., encoded in an instruction or stored in the index register 930) and width might result in a region “wrapping” to the next register in the register file 920. For example, a region of byte-size data elements having an origin of R2.6 and a width of eight would include the last bytes of R2 along with the first six bytes of R3. Similarly, a region might wrap from the bottom of the register file 920 to the top (e.g., from R4 to R0).

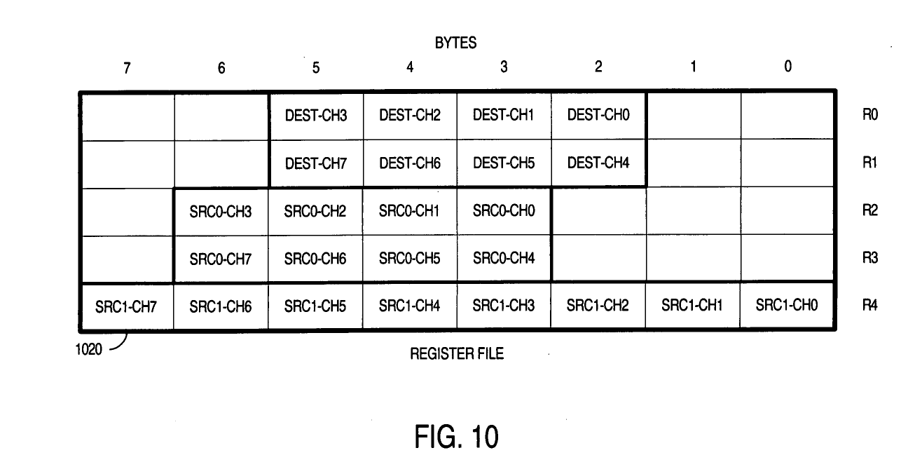

The SIMD execution engine 910 may add each byte in the described SRC1 region to a corresponding byte in the described SRC0 region and store the results the described DEST region in the register file 920. For example, FIG. 10 illustrates execution channel mapping in the register file 920 according to some embodiments. In this case, data elements are arranged within a described region in a row-major order. Consider, for example, channel 6 of the execution engine 910. This channel will add the value stored in byte six of R4 to the value stored in byte five of R3 and store the result in byte four of R1. According to other embodiments, data elements may arranged within a described region in a column-major order or using any other mapping technique.

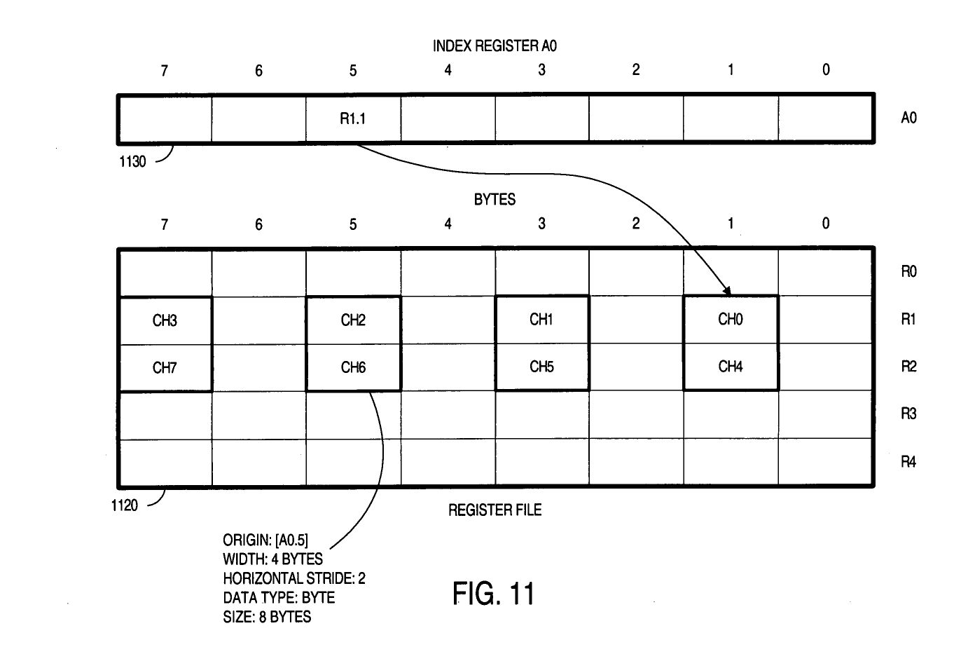

FIG. 11 illustrates a region description including a “horizontal stride” according to some embodiments. The horizontal stride may, for example, indicate an offset between data elements within a row of a register file 1120. In particular, the region described in FIG. 7 is for eight single-byte data elements (e.g., the region might be appropriate when only eight channels of a sixteen-channel SIMD execution engine are being used by a machine code instruction). The region is four bytes wide, and therefore two data elements high (such that the region will include eight data elements) and, as illustrated by the value stored at location 5 of index register A0, the origin of the region is R1.1 (byte 1 of R1). Note that a notation similar to that used to describe origins within registers has been used for the index register A0 (with “A0” indicating index register A0 and “.5” indicating location five within the index register).

In this case, a horizontal stride of two has been described. As a result, each data element in a row is offset from its neighboring data element in that row by two bytes. For example, the data element associated with channel 5 of the execution engine is located at byte 3 of R2 and the data element associated with channel 6 is located at byte 5 of R2. In this way, a described region may not be contiguous in the register file 1120. Note that when a horizontal stride of one is described, the result would be a contiguous 4×2 array of bytes beginning at R1.1 in the two dimensional map of the register file 1120.

The region described in FIG. 11 might be associated with a source operand, in which case data may be gathered from the non-contiguous areas when an instruction is executed. The region described in FIG. 11 might also be associated with a destination operand, in which case results may be scattered to the non-contiguous areas when an instruction is executed.

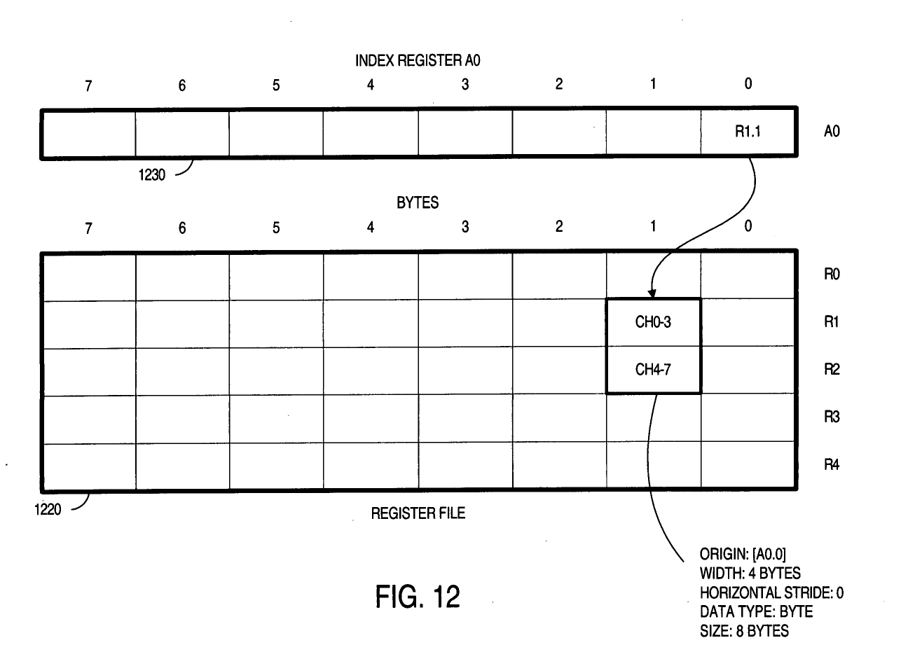

FIG. 12 illustrates a region description including a horizontal stride of “zero” according to some embodiments. As with FIG. 11, the region is for eight single-byte data elements and is four bytes wide (and therefore two data elements high). Because the horizontal stride is zero, however, each of the four elements in the first row map to the same physical location in the register file 1220 (e.g., they are offset from their neighboring data element by zero). As a result, the value in R1.1 (defined in the index register A0 at location [A0.0]) is replicated for the first four execution channels. When the region is associated with a source operand of an “add” instruction, for example, that same value would be used by all the first four execution channels. Similarly, the value in R2.1 is replicated for the last four execution channels.

According to some embodiments, the value of a horizontal stride may be encoded in an instruction. For example, a 3-bit field might be used to describe the following eight potential horizontal stride values: 0, 1, 2, 4, 8, 16, 32, and 64. Moreover, a negative horizontal stride may be described according to some embodiments.

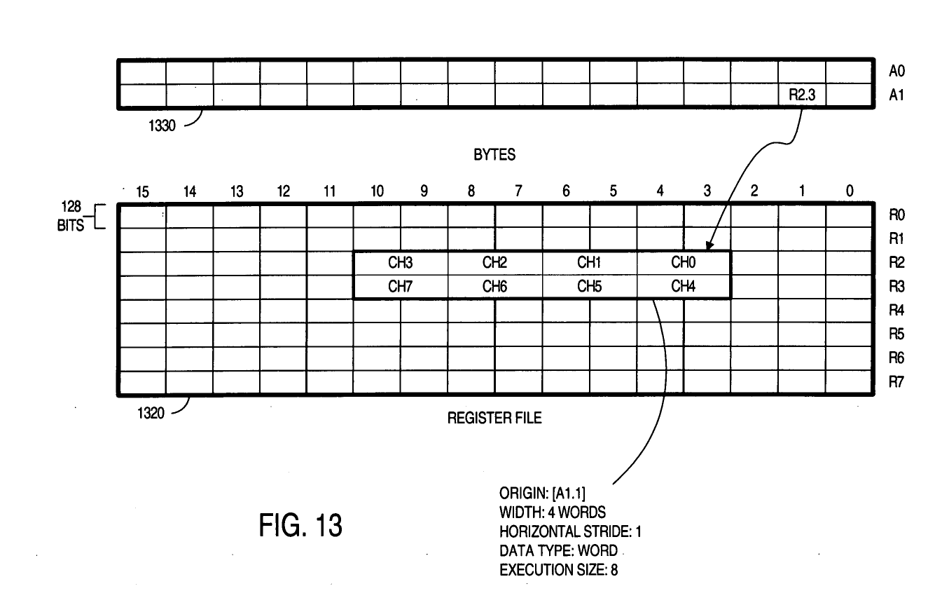

Note that a region may be described for data elements of various sizes. For example, FIG. 13 illustrates a region description for word type data elements according to some embodiments. In this case, the register file 1320 has eight sixteen-byte registers (R0 through R7, each having 128 bits), and the region begins at R2.3 as defined in an index register 1330. Note that the index register 1330 illustrated in FIG. 13 has multiple registers (A0 and A1). The execution size is eight channels, and the width of the region is four data elements. Moreover, each data element is described as being one word (two bytes), and therefore the data element associated with the first execution channel (CH0) occupies both byte 3 and byte 4 of R2. The horizontal stride of this region is one. In addition to byte and word type data elements, embodiments may be associated with other types of data elements (e.g., bit or float type elements).

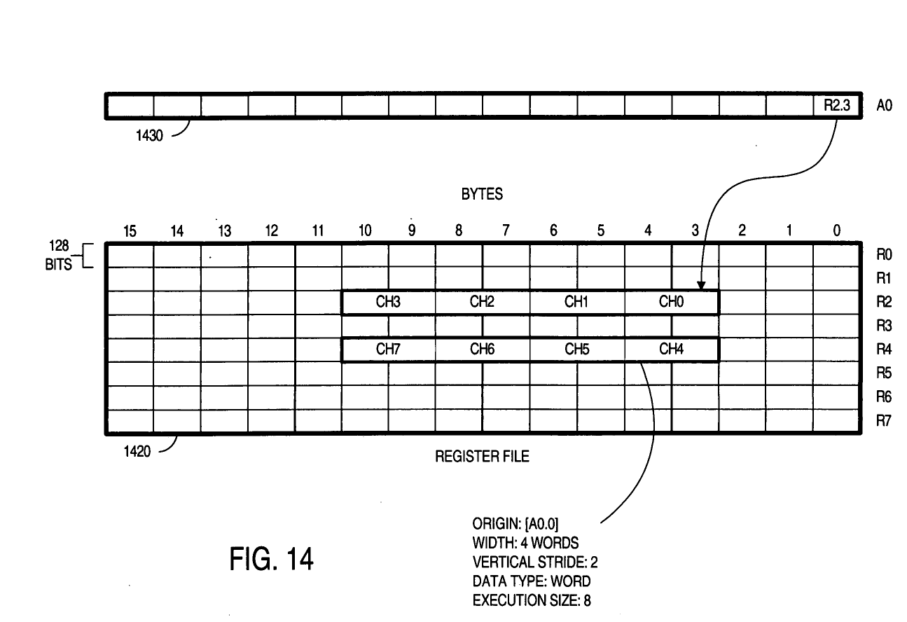

FIG. 14 illustrates a region description including a “vertical stride” according to some embodiments. The vertical stride might, for example, indicate a row offset between rows of data elements in a register file 1420. As in FIG. 13, the register file 1420 has eight sixteen-byte registers (R0 through R7), and the region begins at R2.3 (as defined in an index register 1430). The execution size is eight channels, and the width of the region is four single-word data elements (implying a row height of two for the region). In this case, a vertical stride of two has been described. As a result, each data element in a column is offset from its neighboring data element in that column by two registers. For example, the data element associated with channel 3 of the execution engine is located at bytes 9 and 10 of R2 and the data element associated with channel 7 is located at bytes 9 and 10 of R4. As with the horizontal stride, the described region is not contiguous in the register file 1020. Note that when a vertical stride of one is described, the result would be a contiguous 4×2 array of words beginning at R2.3 in the two dimensional map of the register file 1020.

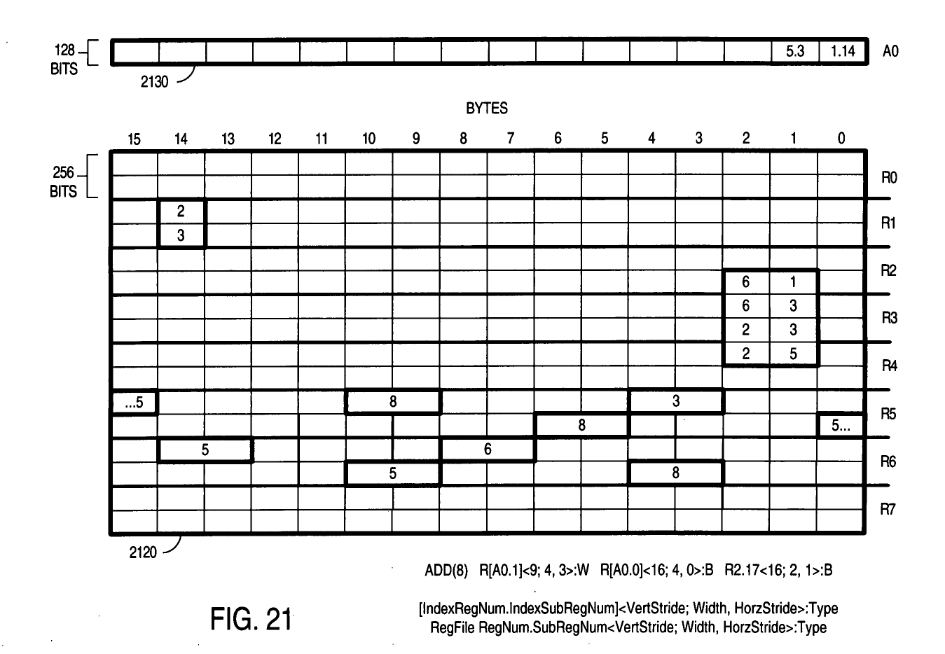

The region described in FIG. 14 might be associated with a source operand, in which case data may be gathered from the non-contiguous areas when an instruction is executed. The region described in FIG. 14 might also be associated with a destination operand, in which case results may be scattered to the non-contiguous areas when an instruction is executed. According to some embodiments, a vertical stride might be described as data element column offset betweens rows of data elements (e.g., as described with respect to FIG. 21). Also note that a vertical stride might be less than, greater than, or equal to a horizontal stride.

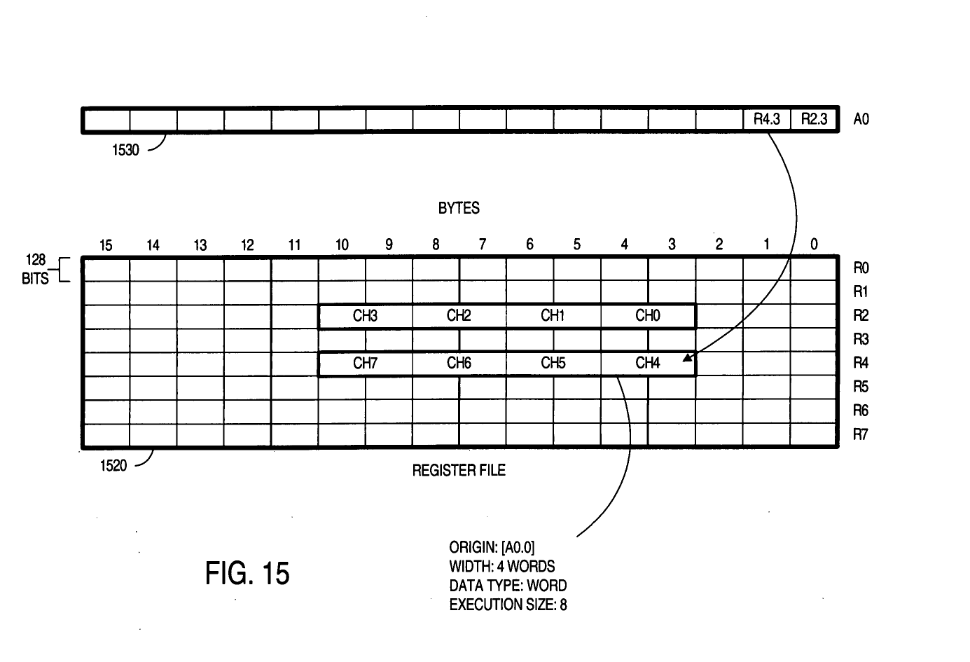

According to some embodiments, an index register stores a single value describing an origin of a region. According to other embodiments, an index register may store multiple values to describe a region. For example, FIG. 15 illustrates a register file 1520 wherein an index register 1530 stores values indicating the origin of each row in a region. In this case, location A0.0 stores the start of the first row (R2.3) while A0.1 stores the start of the second row (R4.3). As with FIG. 14, each data element in a column is offset from its neighboring data element in that column by two registers. For example, the data element associated with channel 3 of the execution engine is located at bytes 9 and 10 of R2 and the data element associated with channel 7 is located at bytes 9 and 10 of R4.

In this example, multiple locations in the index register 1530 may each point to a register sub-region as defined by an immediate instruction field. For example, the horizontal dimension may be described by the immediate terms of the instruction word while the vertical dimension (e.g., the origin of each row) is described in the index register 1530. Such an embodiment may be associated with, for example, a one-dimensional field and/or a gathering of vector mode (e.g., in connection with a replicated scalar or a one-dimensional array).

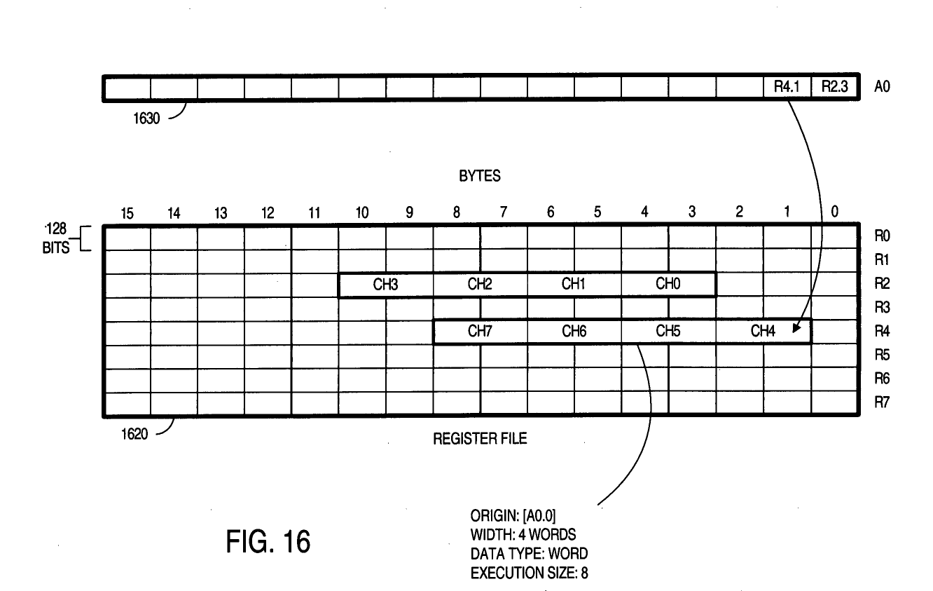

Note that rows of data elements defined in the index register 1530 do not need to be aligned to each other. For example, FIG. 16 illustrates a register file 1620 wherein an index register 1630 stores values indicating the origin of each row in a region. In this case, location A0.0 stores the start of the first row (R2.3) while A0.1 stores the start of the second row (R4.4), which is not aligned with the first row.

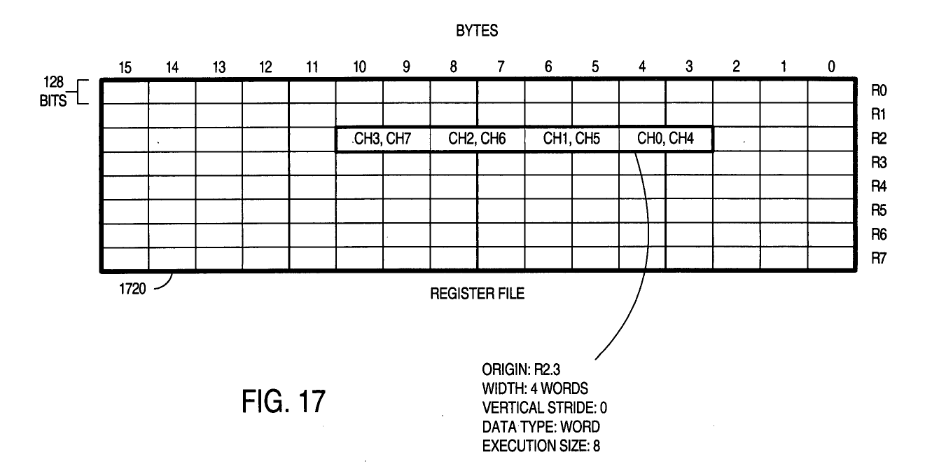

FIG. 17 illustrates a region description including a vertical stride of “zero” according to some embodiments. As with FIG. 13, the region is for eight single-word data elements and is four words wide (and therefore two data elements high). Because the vertical stride is zero, however, both of the elements in the first column map to the same location in the register file 1130 (e.g., they are offset from each other by zero). As a result, the word at bytes 3-4 of R2 is replicated for those two execution channels (e.g., channels 0 and 4). When the region is associated with a source operand of a “compare” instruction, for example, that same value would be used by both execution channels. Similarly, the word at bytes 5-6 of R2 is replicated for the channels 1 and 5 of the SIMD execution engine, etc. In addition, the value of a vertical stride may be encoded in an instruction, and, according to some embodiments, a negative vertical stride may be described.

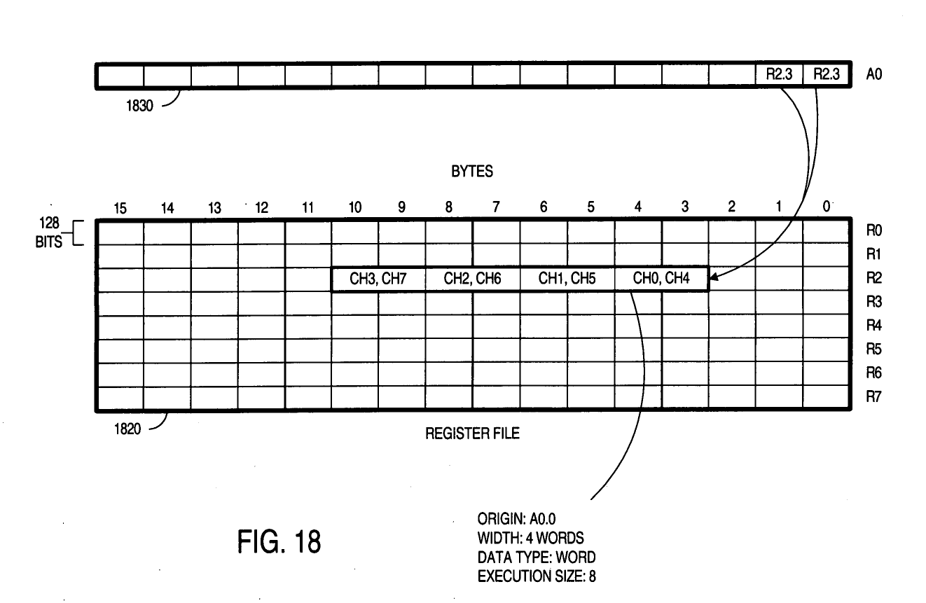

FIG. 18 illustrates how an identical region might be created using values stored in an index register 1830. The region again is for eight single-word data elements and is four words wide (and therefore two data elements high). Because the start of the first row and the start of the second row are defined in the index register 1830 as being the same location (R2.3), the word at bytes 3-4 of R2 is replicated for those two execution channels (e.g., channels 0 and 4).

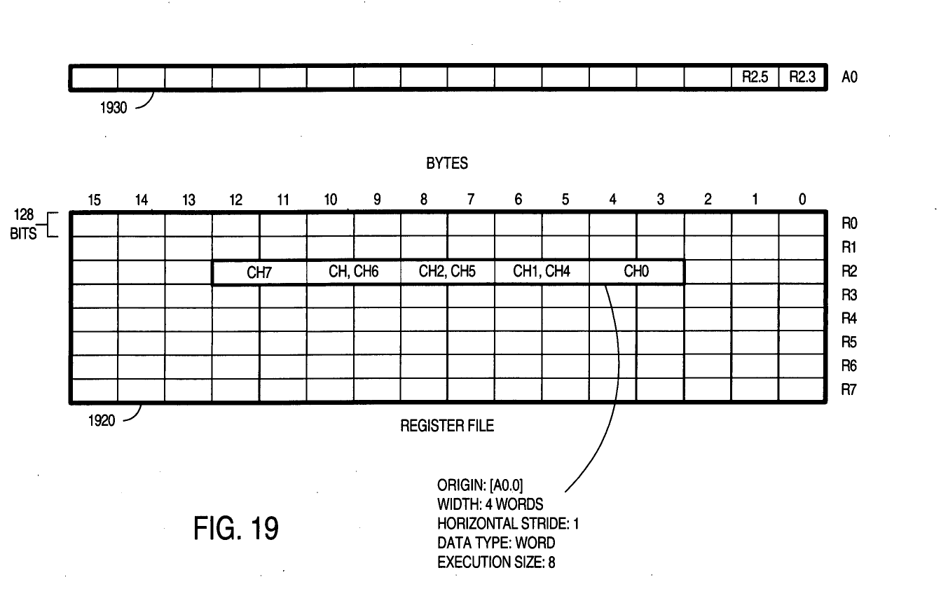

FIG. 19 illustrates a register file 1920 and an index register 1930 according to another embodiment. In this case, the first “row” of the array defined by the region comprises four words from R2.3 (as indicated by location A0.0 in the index register 1930) through R2.10. The second row is offset by a single word and spans from R2.5 (as indicated by location A0.1 in the index register 1930) through R2.12. Such an implementation might be associated with, for example, a sliding window for a filtering operation.

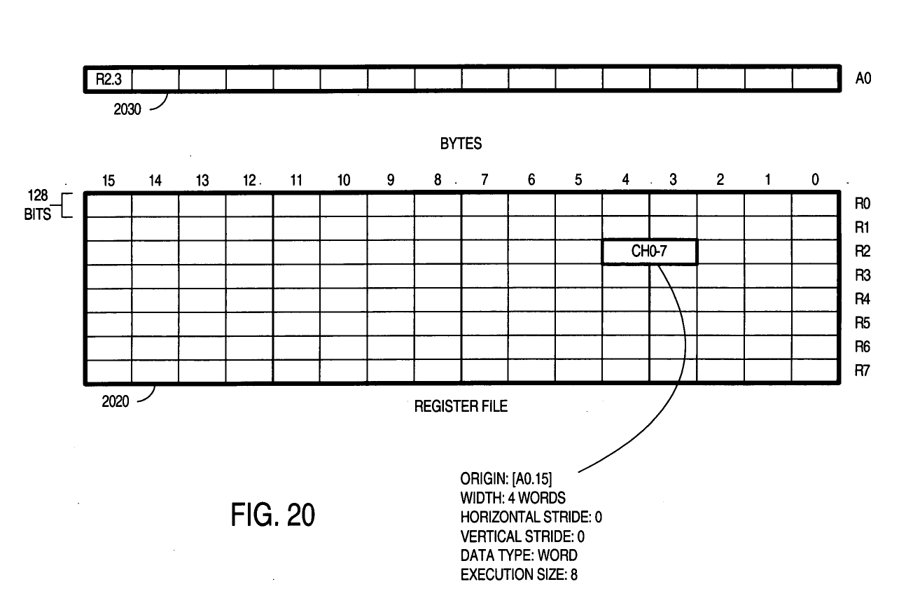

FIG. 20 illustrates a region description wherein both the horizontal and vertical strides are zero according to some embodiments. As a result, all eight execution channels are mapped to a single location in the register file 2020 (e.g., bytes 3-4 of R2 as defined by location A0.15 in the index register 2030). When the region is associated with a machine code instruction, therefore, the single value at bytes 3-4 of R2 may be used by all eight of the execution channels.

Note that different types of descriptions may be provided for different instructions. For example, a first instruction might define a destination region as a 4×4 array while the next instruction defines a region as a 1×16 array. Moreover, different types of regions may be described for a single instruction.

Consider, for example, the register file 2120 illustrated in FIG. 21 having eight thirty-two-byte registers (R0 through R7, each having 256 bits). Note that in this illustration, each register is shown as being two “rows” and sample values are shown in each location of a region.

In this example, regions are described for an operand in one of two ways:
RegFile RegNum.SubRegNum<VertStride; Width, HorzStride>:type and
IndexRegNum.IndexSubRegNum<VertStride; Width, HorzStride>:type
   where RegFile identifies the name space for the register file 2120, RegNum points directly to a register in the register file 2120 (e.g., R0 through R7) and SubRegNum is a byte-offset from the beginning of that register. Such a definition might be associated with, for example, an immediate addressing mode of operation. Moreover, IndexRegNum points to the index register 2130 register and IndexSubRegNum is a byte-offset from the beginning of the index register 2130. Such a definition might be associated with, for example, a register-indirect-register addressing mode of operation. The VertStride describes a vertical stride, Width describes the width of the region, HorzStride describes a horizontal stride, and type indicates the size of each data element (e.g., “b” for byte-size and “w” for word-size data elements). According to some embodiments, SubRegNum may be described as a number of data elements (instead of a number of bytes). Similarly, VertStride, Width, and HorzStride could be described as a number of bytes (instead of a number of data elements).

FIG. 21 illustrates a machine code add instruction being executed by eight channels of a SIMD execution engine. In particular, each of the eight bytes described by R2.17<16; 2, 1>b (SRC1) are added to each of the eight bytes described by R[A0.0]<16; 4, 0>:b (SRC0, beginning at R1.14 as defined in the index register 2130). The eight results are stored in each of the eight words described by R[A0.1]<18; 4, 3>:w (DEST, beginning at R5.3 as defined in the index register 2130).

SRC1 is two bytes wide, and therefore four data elements high, and begins in byte 17 of R2 (illustrated in FIG. 14 as the second byte of the second row of R2). The horizontal stride is one. In this case, the vertical stride is described as a number of data element columns separating one row of the region from a neighboring row (as opposed to a row offset between rows as discussed with respect to FIG. 10). That is, the start of one row is offset from the start of the next row of the region by 16 bytes. In particular, the first row starts at R2.17 and the second row of the region starts at R3.1 (counting from right-to-left starting at R2. 17 and wrapping to the next register when the end of R2 is reached). Similarly, the third row starts at R3.17.

SRC0 is four bytes wide, and therefore two data elements high, and begins at R1.14 (based on the value stored in the index register 2130). Because the horizontal stride is zero, the value at location R1.14 (e.g., “2” as illustrated in FIG. 14) maps to the first four execution channels and value at location R1.30 (based on the vertical stride of 16) maps to the next four execution channels.

DEST is four words wide, and therefore two data elements high, and begins at R5.3 (based on the value stored at location A0.1 in the index register 2130). Thus, the execution channel will add the value “1” (the first data element of the SRC0 region) to the value “2” (the data element of the SRC1 region that will be used by the first four execution channels) and the result “3” is stored into bytes 3 and 4 of R5 (the first word-size data element of the DEST region).

The horizontal stride of DEST is three data elements, so the next data element is the word beginning at byte 9 of R5 (e.g., offset from byte 3 by three words), the element after that begins at bye 15 of R5 (shown broken across two rows in FIG. 14), and the last element in the first row of the DEST region starts at byte 21 of R5.

The vertical stride of DEST is eighteen data elements, so the first data element of the second “row” of the DEST array begins at byte 7 of R6. The result stored in this DEST location is “6” representing the “3” from the fifth data element of SRC0 region added to the “3” from the SRC1 region which applies to execution channels 4 through 7.

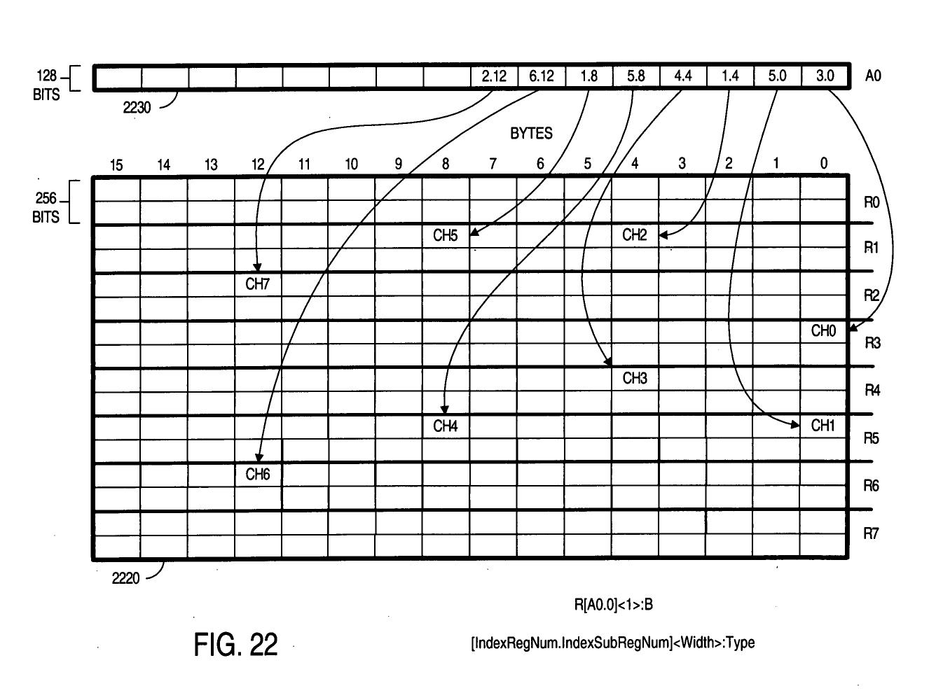

According to some embodiments, an index register may store a value for each data element in a register region (e.g., in connection with a total gathering mode). For example, FIG. 22 illustrates an index register 2230 storing values for each data element in a register region according to some embodiments. In this case, a region in a register file 2220 is defined as having a width of a single data element. Moreover, the location of each data element is defined in the index register 2230. In particular, the data element associated with execution channel CH0 is stored at A0.0 (and is R3.0), the data element associated with execution channel CH1 is stored at A0.1 (and is R5.0), etc.

Because information in the register files may be efficiently and flexibly accessed in different ways, the performance of a system may be improved. For example, machine code instructions may efficiently be used in connection with a replicated scalar, a vector of a replicated scalar, a replicated vector, a two-dimensional array, a sliding window, and/or a related list of one-dimensional arrays. As a result, the amount of data moves, packing, unpacking, and or shuffling instructions may be reduced—which can improve the performance of an application or algorithm, such as one associated with a media kernel. Moreover, a register-indirect-register addressing mode of operation might help an application kernel maintain kernel data in a pre-determined register file location which may further improve performance of a system (especially when there are a relatively large number of registers in a register file).

Note that in some cases, restrictions might be placed on region descriptions. For example, a sub-register origin and/or a vertical stride might be permitted for source operands but not destination operands. Moreover, physical characteristics of a register file might limit region descriptions. For example, a relatively large register file might be implemented using embedded Random Access Memory (RAM), and the cost and power associated with the embedded RAM might depended on the number of read and write ports that are provided. Thus, the number of read and write points (and the arrangement of the registers in the RAM) might restrict region descriptions.

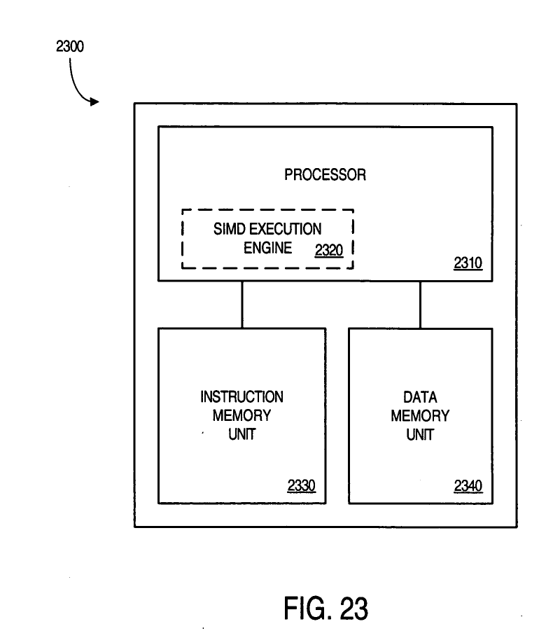

FIG. 23 is a block diagram of a system 2300 according to some embodiments. The system 2300 might be associated with, for example, a media processor adapted to record and/or display digital television signals. The system 2300 includes a processor 2310 that has an n-operand SIMD execution engine 2320 in accordance with any of the embodiments described herein. For example, the SIMD execution engine 2320 might include a register file and an associated index register. The processor 2310 may be associated with, for example, a general purpose processor, a digital signal processor, a media processor, a graphics processor, or a communication processor.

The system 2300 may also include an instruction memory unit 2330 to store SIMD instructions and a data memory unit 2340 to store data (e.g., scalars and vectors associated with a two-dimensional image, a three-dimensional image, and/or a moving image). The instruction memory unit 2330 and the data memory unit 2340 may comprise, for example, RAM units. Note that the instruction memory unit 2330 and/or the data memory unit 2340 might be associated with separate instruction and data caches, a shared instruction and data cache, separate instruction and data caches backed by a common shared cache, or any other cache hierarchy. According to some embodiments, the system 2300 also includes a hard disk drive (e.g., to store and provide media information) and/or a non-volatile memory such as FLASH memory (e.g., to store and provide instructions and data).

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although various ways of describing source and/or destination operands have been discussed, note that embodiments may be use any subset or combination of such descriptions. For example, only source operands might be permitted to have a vertical stride.

According to some embodiments, a description of a register region is encoded in an instruction word for each of the instruction's operands. For example, the register number and sub-register number of the origin may be encoded. In some cases, the value in the instruction word may represent a different value in terms of the actual description. For example, three bits might be used to encode the width of a region, and “011” might represent a width of eight elements while “100” represents a width of sixteen elements.

In this way, a larger range of descriptions may be available as compared to simply encoding the actual value of the description in the instruction word.

Moreover, an instruction word might indicate whether an immediate or a register-indirect-register addressing mode should be used. The instruction may further include a portion that contains, depending on the addressing mode, one of: (i) a location in a register file (e.g., a register number and/or a sub-register) or (ii) a location in an index register (e.g., an index register number and/or index sub-register number).

As described herein, an index register may contain a value that represents an origin of a register region. According to some embodiments, the index register may include other values to describe the register region instead of, or in addition to, the origin. For example, the width, horizontal stride, or data type of a register region might be stored in an index register.

The several embodiments described herein are solely for the purpose of illustration. Persons skilled in the art will recognize from this description other embodiments may be practiced with modifications and alterations limited only by the claims.

What is claimed is:

1. A method, comprising:
retrieving a value from a location in an index register;
determining a region in a register file based at least in part on the value; and
storing information into the determined region of the register file.

2. The method of claim 1, wherein the value is an origin of the region in the register file.

3. The method of claim 1, further comprising:
describing, for an operand, the location in the index register.

4. The method of claim 3, wherein the location in the index register is included in a machine code instruction.

5. The method of claim 4, wherein the operand is a destination operand and further comprising:
retrieving from the index register a value for a source operand;
determining a source operand region in the register file; and
reading information from the source operand region in the register file.

6. The method of claim 3, wherein locations in the index register are described for multiple operands.

7. The method of claim 1, wherein the index register and the register file are associated with a single instruction, multiple data execution engine.

8. The method of claim 7, wherein the region in the register file is to store multiple data elements, each data element being associated with a channel of the execution engine.

9. The method of claim 8, wherein the region is dynamic and further comprising:
describing, for an operand, the region in the register file.

10. The method of claim 9, wherein a plurality of origins are retrieved from the index register to determine the region in the register file.

11. The method of claim 10, wherein an origin is retrieved from the index register for each data element.

12. The method of claim 9, wherein the described region is at least one of: (i) spanning different registers in the register file, (ii) not contiguous in the register file, or (iii) not aligned to registers in the register file.

13. The method of claim 9, wherein the register file includes register rows and register columns, and said describing includes at least one of: (i) a width indicating a number of data elements associated with the described region within a register row, (ii) a horizontal stride indicating an offset between columns of data elements in the register file, (iii) a vertical stride indicating an offset between rows of data elements in the register file, (iv) a data type indicating a size of each data element, or (v) an execution size indicating a number of data elements associated with the described region.

14. The method of claim 1, further comprising:
determining if an instruction is associated with at least one of: (i) an immediate addressing mode, (ii) a register addressing mode, or (iii) a register-indirect-register addressing mode.

15. The method of claim 14, wherein the instruction includes an encoded portion to store one of: (i) the location in the index register or (ii) a location in the register file.

16. The method of claim 1, wherein the index register is a portion of the register file.

17. An apparatus, comprising:
a single instruction, multiple data execution engine;
a register file on the same die as the execution engine; and
an index file on the same die as execution engine and the register file, the index file to store a value describing a region in the register file where information will be stored.

18. The apparatus of claim 17, wherein the value is an origin of the region and further comprising:
an instruction mapping engine to (i) determine, for an operand of a machine code instruction, a portion of the register file based at least in part on the origin, wherein the determined portion is to store information for multiple execution channels the execution engine, and (ii) arrange for the information to be stored into the register file in accordance with the determined region.

19. The apparatus of claim 18, wherein the determined region is dynamic and is described at least in part based on information encoded in the machine code instruction.

20. A system, comprising:
an n-channel single instruction, multiple-data execution engine, n being an integer greater than 1;
a register file;
an index file to store an origin of a region in the register file where information will be stored by the execution engine; and
a graphics data unit.

21. The system of claim 20, further comprising:
an instruction mapping engine to (i) scatter data to non-contiguous areas of the register file, and (ii) gather data from non-contiguous areas of the register file.

22. The system of claim 20, wherein index file is to store multiple origins associated with a single region.
